(19) United States
(12) Patent Application Publication
(10) Pub. No.: US 2020/0171639 A1
(43) Pub. Date: Jun. 4, 2020

(54) NAILING GUARD

(71) Applicant: Grant Gildroy, San Rafael, CA (US)

(72) Inventor: Grant Gildroy, San Rafael, CA (US)

(21) Appl. No.: 16/697,949

(22) Filed: Nov. 27, 2019

Related U.S. Application Data
(60) Provisional application No. 62/774,028, filed on Nov. 30, 2018.

(51) Int. Cl. B25C 3/00

(52) U.S. Cl. CPC B25C 3/008

(57) ABSTRACT

A finish carpentry nailing guard adapted for use in protecting workpiece surfaces from damage by hammers while driving nails and/or from nail pulling devices when removing nails, the guard including a unitary block having complementary top side and bottom side basins, each including concavities which define a tapered annulus with an aperture.

### CROSS REFERENCES TO RELATED APPLICATIONS

The present application claims the benefit of U.S. Provisional Patent Application Ser. No. 62/774,028, filed Nov. 30, 2018 (Nov. 30, 2018), which application is incorporated in its entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### SEQUENCE LISTING

Not applicable.

### BACKGROUND OF THE INVENTION

### Field of the Invention

The present invention relates generally to carpentry tools, and more particularly to a finish carpentry nailing guard used to prevent damage to the surface worked upon when driving or pulling nails.

### Background Discussion

Nail starters, nailing guards, nailing shields are known. Indeed, U.S. Pat. No. 6,520,050 B1 to the present inventor, Gildroy, teaches such apparatus. The nailing guard of the '050 patent (“the existing tool”) works remarkably well. However, it does not facilitate flush or substantially flush nailing while still protecting the work surface from direct hammer blows, and it cannot be used to compress and integrate building materials.

### BRIEF SUMMARY OF THE INVENTION

To resolve the limitations or shortcomings of the prior art, including the inventor's prior art (variously “the existing tool” and/or “the “050 nailing guard”), the innovative nailing guard of the present invention includes several innovations. As with the '050 nailing guard, the present invention is designed to be used in general construction with hand-held finish hammers, pry-bars, and nail-pullers.

However, the nailing guard differs significantly from the existing tool in that it allows substantially improved flush-nailing while offering greater protection of the work surface from marring due to hammer blows. It also offers better protection of work surfaces during prying and nail-pulling actions, as well as better performance as a “beater block”. Beyond the foregoing, the nailing guard can be used to compress and integrate building materials, a crucial construction function that the existing tool does not provide at all. These improvements and enhanced functions are attributable to two unique nailing guard features:

First, the nailing guard is fabricated from a polycarbonate material having substantially greater flexural strength and a higher flexural modulus than the existing tool. It is both a “thicker” block of polycarbonate material and a polycarbonate having greater flexural strength and a higher flexural modulus, which (a) eliminates the existing tool's tendency to flex and thereby mar the work surface during nailing and prying actions, (b) provides better performance as a beater block, (c) allows the nailing guard to be used for the compression and integration of building materials during construction, and (d) provides greater product durability and longevity.

Second, four precisely-designed circular basins are integrated into the body of the nailing guard. These basins enable the user to drive a nail to the lowest possible level above the work surface (hereafter the “critical nail head elevation”) and to then complete the flush nailing process without risking hammer dents in the finished product. Top basins enable critical closeness nail driving; bottom basins prevent the final hammer strikes from marring the work surface.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of claims presented in a non-provisional patent application claiming the benefit of the filing date of the instant application.

### BRIEF DESCRIPTION OF SEVERAL VIEWS OF THE DRAWINGS

FIG. 1 is an upper perspective view of the nailing guard of the present invention;

FIG. 2 is a bottom view thereof;

FIG. 3 is a top plan view thereof;

FIG. 4 is a side view in elevation thereof;

FIG. 5 is an elevational end view;

FIG. 6 is a cross-section end view taken along section line 6-6 of FIG. 3;

FIG. 7 is a top plan view showing a hammer employed to drive a nail while using the inventive nailing guard;

FIG. 8 is a cross-sectional side view in elevation thereof;

FIG. 9A is a detailed cross-sectional side view in elevation taken along cut line 9-9 of FIG. 8, this view illustrating use of the nailing guard to drive a nail to the critical nail head elevation;

FIG. 9B is the same view showing the nailing process progressed to setting the nail flush and compressing building materials to eliminate open gaps between material layers; and

FIG. 10 is a more detailed cross-sectional side view in elevation showing the nailing guard in use in driving a nail to the critical nail head elevation.

### DETAILED DESCRIPTION OF THE INVENTION

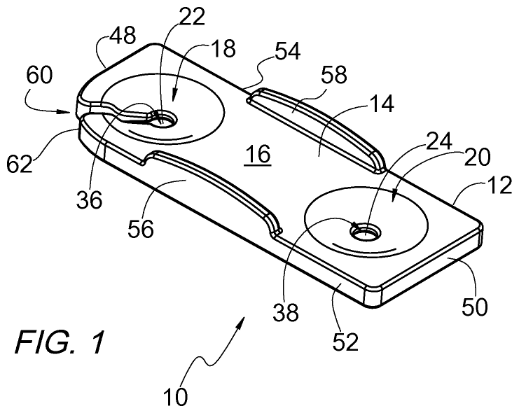

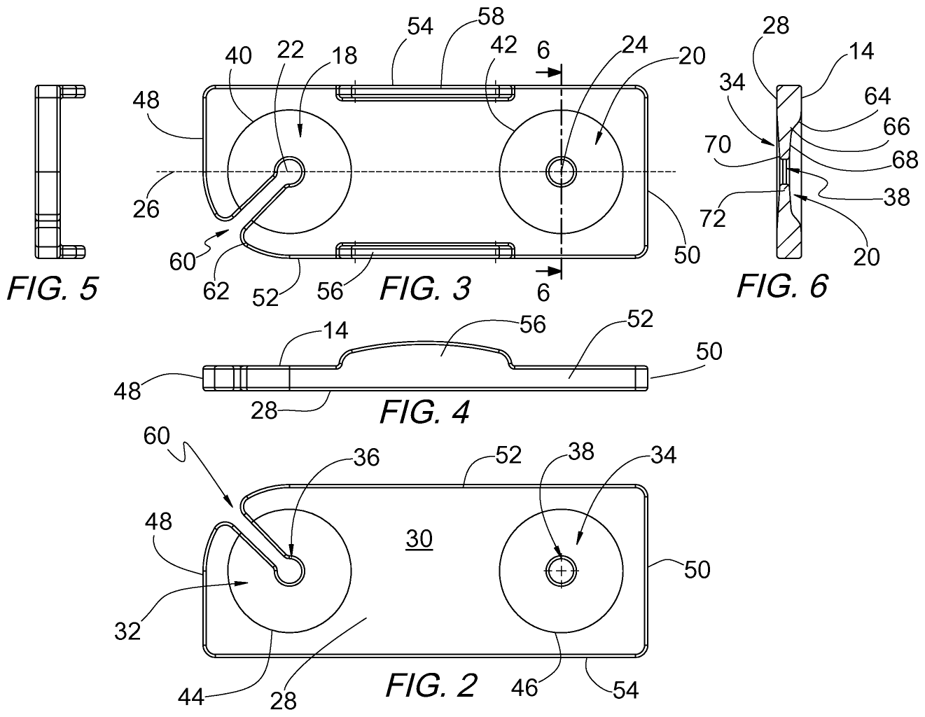

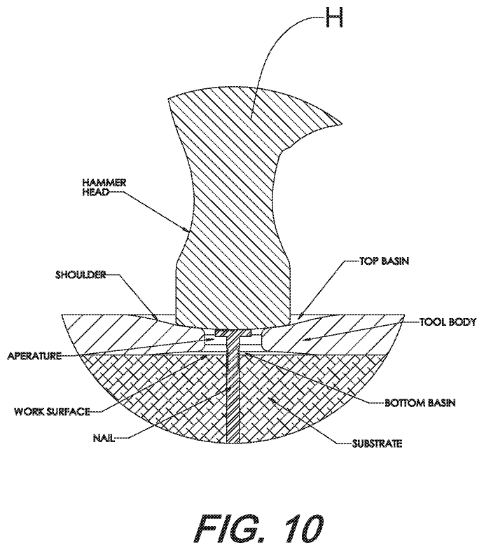

Referring to FIGS. 1 through 10, wherein like reference numerals refer to like components in the various views, there is illustrated therein a new and improved nailing guard, generally denominated 10 herein, and variously referred to as “the present invention” and/or “nailing guard.”

The inventive nailing guard, which also by the proprietary name of HAMMERMATE™, is made of a transparent polycarbonate material. The body 12 is a rectangular block of generally uniform thickness about its exterior.

Interiorly, the body of the nailing guard has a top side 14 and top surface 16 that includes first and second circular top side basins 18, 20 identical to one another in size, contour, and depth. The centers 22, 24 of the first and second top side basins are disposed along the longitudinal centerline 26 of the body.

The bottom side 28 and bottom surface 30 of the body includes first and second circular bottom side basins 32, 34 having centers collocated (i.e., identical) with the centers of the basins in the top side. Apertures 36, 38 extend around and through the centers of the top side basins and bottom side basins, thus through the body of the tool.

The bottom side basins are also identical to one another in size and contour, but differ in depth and contour from the top side basins. The diameter of each of the top side basins and bottom side basins are identical, such that the circumferential edges 40, 42 of the first top side basin and second top side basin align directly over the circumferential edges 44, 46 of the first and second bottom side basins. The respective circumferential edges at each end of the body are spaced from their most proximate and respective first and second ends 48, 50 and first and second sides 52, 54, as considered with respect to tangents to the circumferential edges parallel to the most proximate end or side.

As more fully described below, the top and bottom basins work in concert to enable the user to achieve a precise, professional nailing result.

First and second rectangular and integral rails 56, 58 extend upwardly from the top side to provide gripping structures for easy manipulation of the tool. The rails provide a distinct advantage in the nailing guard's performance, in that, (1) they contribute additional rigidity to the nailing guard, further counteracting any tendency to the tool to flex under hammer blows; (2) they act as finger grips, providing the user with a convenient means of lifting and positioning the nailing guard during use.

A diagonal slot 60 extends from a rounded corner 62 joining the first end 48 and first side 52.

As noted, each of the first and second top side basins 18, 20 consists of a circular recess with a gently curved shoulder that blends seamlessly with the top surface of the nailing guard. Referring to FIG. 6, which best shows the contours of the top side and bottom side basins, the top side basins include a steep upper portion 64, and shoulder 66, and a lower portion 68 extending from the shoulder to the aperture. The bottom side basins include a single slope 70 from the circumferential edge to the aperture. Together, the top side basins and bottom side basins form a tapered annulus 72 which is slightly elevated from a surface when the nailing guard is placed on a flat surface. It should be noted that the concave lower portions of the top side basins are contoured to conform generally to the slightly convex striking surface of the common hand-held finish hammer face. The aperture at the basin center is the opening through which a nail head protrudes during a nail-driving process. It will be noted, as well, that the bottom side basins slope more gently and are shallower than the top side basins.

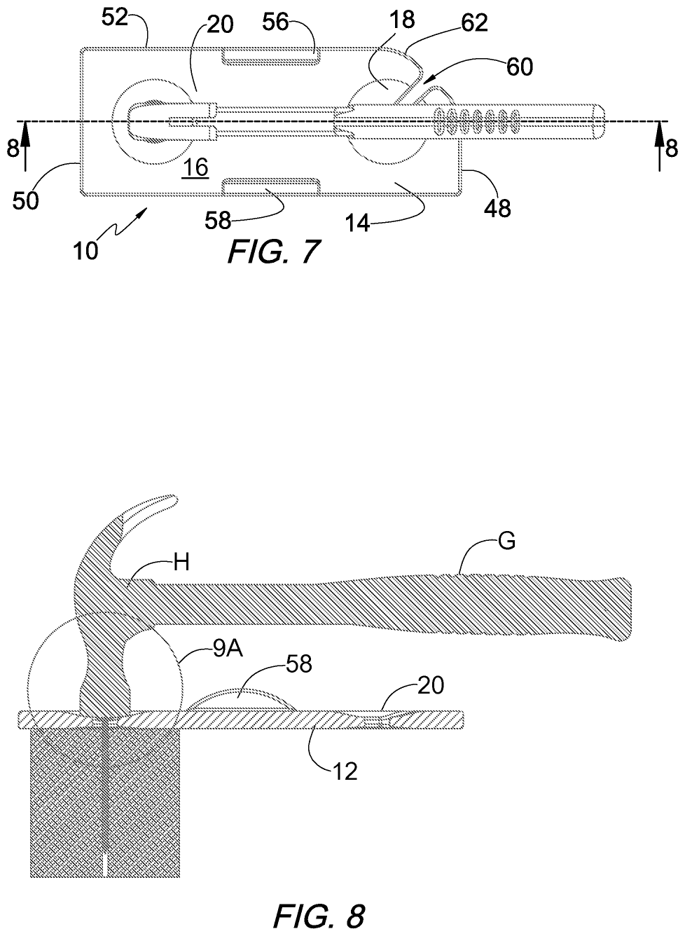

Operational Features: Referring next to FIGS. 7-10, the top side basins enable the user to achieve critical nail height during the nailing process. Critical nail height refers to the elevation of the nail head above the work surface, at which the shaft of the nail is unlikely to fail or bend when properly struck on the head with a hammer. Establishing critical nail height is essential to a successful final flush nailing result. The height is typically determined by the ratio of the length of the nail shaft to the diameter of the nail shaft. The ratio is generally no greater than 3:1, and the lower the ratio the better. The nailing guard of the present invention is designed with upper and lower basins to enable a user to easily achieve the critical nail height while providing protection to the underlying work surface. For every incremental increase in the height of the nail, there is an increased likelihood that the nail shaft will bend when the nail head is struck by a hammer blow. This also increases the likelihood that the hammerhead will deflect off the nail and strike the work surface. If this happens, the HAMMERMATE provides solid, substantial protection to prevent any damage to the work surface.

Before employing the nailing guard, the user determines the point at which he or she wants the nail to penetrate the work surface, places the point of the nail on that precise location, and applies a light hammer strike to the head of the nail to set the nail in place.

The user then (1) places the nailing guard over the nail so that the nail extends through the above-described aperture; (2) holds the nailing guard firmly against the work surface using his or her free hand and placing it a safe distance from where he or she intends the next hammer strikes to fall; (3) strikes the nail head with the hammer until the nail head is driven slightly lower than the rim of the aperture.

Here it is important to note the essential role played by the precise design of the top side basins. The slightly concave contour of the basin lowest surface, which conforms to the slightly convex striking surface of the hammer face, is the feature that enables the user to actually drive the nail head slightly lower than the rim of the aperture, thereby achieving critical nail head elevation. In addition, the contour of the top side basins operate to deflect the hammer face away from the basin edges and towards the center of the nail head during step (3) above, minimizing the likelihood of undesirable off-center hammer strikes.

After driving the nail head slightly lower than the rim of the aperture as described, the user (4) lifts the nailing guard up and off the nail; (5) places nailing guard's bottom flat surface over the top of the nail head; and (6) strikes the top surface of the nailing guard directly over the nail head, easily seen by virtue of the nailing guard's transparency, until the nail head is flush with the work surface. This last step can usually be achieved with a single hammer strike.

The bottom side basins work in concert with the top side basins to prevent hammer blows from marring the work surface. Throughout the flush nailing process described above, the substantial polycarbonate material absorbs and distributes the force of each hammer blow throughout the nailing guard, sparing the work surface. In addition, the precise curvature of the bottom basin directly beneath the top basin prevents the aperture from coming into contact with and marring the work surface during the nailing process. As this occurs, the bottom basin flexes slightly downward with each hammer blow, and the gently curved shoulder of the basin's rim prevents the bottom basin itself from marring the work surface. Thus, the nailing guard allows the user to drive the nail head flush with the work surface while preventing marring of the work surface by hammer blows.

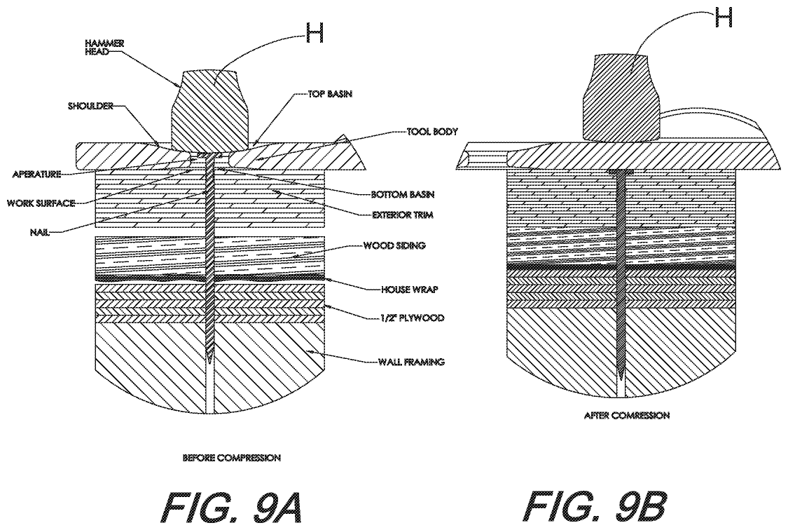

When nailing through multiple layers of building materials, after each layer of building material is flush-nailed in place, it is essential to compress each layer of building material with the building material immediately beneath it, eliminating to the greatest extent possible any open gaps remaining between these materials. The inventive tool facilities this function without marring the work surface, as shown in FIGS. 9A-9B.

In an exterior application, the nailing guard is used to compress and eliminate gaps between the framing, the plywood sheathing, the moisture barrier, the wood or manufactured siding, and the trim. After applying each separate exterior building material, the nailing guard is placed along the nail line between each nail head and struck several times, so as to achieve the tightest possible bond between the material being applied and the material immediately beneath it. This same series of steps, with the same advantages, can be employed in interior work or in projects involving multiple layers of materials.

On occasion the compression function can cause a formerly flush nail head to stand proud (i.e., to extend slightly above the surrounding building material that has been compressed). In this event, the nailing guard is placed over that nail head with the nail head as close as possible to the center of the nailing guard and away from the basins. Hammer blows are then delivered to the top surface of the nailing guard directly over the nail head until the nail head is flush against the newly-compressed building material.

The nailing guard is also an excellent companion tool to a curved-claw hammer, nail-pulling bar, or other prying device when removing nails or other objects from a work surface. Because of its substantial thickness and material properties, the nailing guard is resistant to flexing when used as a protective shield between the work surface and the prying device. The highly concentrated pressure caused by a prying device in use is distributed throughout the entire body of the nailing guard, preventing this pressure from damaging the work surface.

The nailing guard can be used as a “beater block” to persuade various construction-related components (such as cabinet parts and trim) into proper alignment without causing the kind of damage that would typically be caused by using a hammer alone. In addition, the nailing guard's rectangular rail-like structures provide additional surface area along the nailing guard's edges: (1) on the side where the hammer strikes will be applied directly for this purpose, and (2) on the opposite side, where this additional surface area will disperse the impact of the hammer strikes and reduce marring of the work surface.

Because of its transparency and rigidity, the nailing guard is an ideal tool for setting flush-mounted door, cabinet, window, and lock set metal hardware. The tool can be perfectly aligned with the hardware, and struck precisely over the hardware, while providing protection for valuable decorative metal finishes and for the surrounding wood finishes as well.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A nailing guard, comprising a unitary block having a top side and a bottom side, each of said top side and bottom side having at least one pair of a complementary and axially opposing circular top side basin and bottom side basin defining a tapered annulus with an aperture.

2. The nailing guard of claim 1, wherein said unitary block is rectangular and cuboid and has a uniform thickness from said top side to said bottom side.

3. The nailing guard of claim 1, wherein each of said opposing circular basins are identical to one another in size, contour, and depth.

4. The nailing guard of claim 3, wherein each aperture of said annulus of said basins has a center disposed along a longitudinal centerline of said unitary block.

5. The nailing guard of claim 1, having two pairs of complementary and axially opposing circular top side and bottom side basins.

6. The nailing guard of claim 5, wherein said bottom side basins are identical to one another in size and contour, but differ in depth and contour from said top side basins.

7. The nailing guard of claim 6, wherein said top side basins include a first top side basin and a second top side basin, and said bottom side basins include a first bottom side basin and a second bottom side basin, and the diameters of each of said first and second top side basins and first and second bottom side basins are identical, such that the circumferential edges of said first top side basin and said second top side basin align directly over the circumferential edges of the said first and second bottom side basins.

8. The nailing guard of claim 1, further including first and second rectangular and integral rails extending upwardly from said top side to provide gripping structures.

9. The nailing guard of claim 8, wherein one corner of said unitary block is rounded and a diagonal slot extends from said rounded corner to one of said complementary and axially opposing circular top side basins and bottom side basins.

10. The nailing guard of claim 1, wherein each of said top side basins includes a circular recess with a gently curved shoulder that blends into a top surface of said unitary block.

11. The nailing guard of claim 10, wherein said bottom side basins include a single slope from a circumferential edge of said basin to said aperture.

12. The nailing guard of claim 1, wherein said bottom side basins include a single slope from a circumferential edge of said basin to said aperture.

13. The nailing guard of claim 1, wherein concave lower portions of said top side basins are contoured to conform generally to convex striking surface contours of a hand-held finish hammer face.

14. The nailing guard of claim 1, wherein said bottom side basins have a shallower slope than said top side basins.
